(19) United States
(12) Patent Application Publication
(10) Pub. No.: US 2016/0140778 A1
(43) Pub. Date: May 19, 2016

(54) METHOD AND SYSTEM FOR IDENTIFYING DAMAGE CAUSED TO A VEHICLE

(71) Applicant: RENAULT s.a.s., Boulogne Billancourt (FR)

(72) Inventors: Olivier BAILLY, Les Essarts Le Roi (FR); Philippe LABREVOIS, Marcilly sur Eure (FR)

(73) Assignee: RENAULT s.a.s., Boulogne Billancourt (FR)

(21) Appl. No.: 14/897,545

(22) PCT Filed: May 28, 2014
(86) PCT No.: PCT/FR2014/051253

§ 371 Date: Feb. 2, 2016

(30) Foreign Application Priority Data
Jun. 12, 2013 (FR) 1355448

(51) Int. Cl. G07C 5/00; G06T 7/00; G07C 5/08; G06K 9/62; G06K 9/00; B60R 11/04; G06Q 10/08; H04N 5/33

(52) U.S. Cl. CPC G07C 5/008; G06Q 10/087; G06T 7/004; H04N 5/33; G06K 9/6201; G06K 9/00832; B60R 11/04; G07C 5/0808; G06T 2207/30244; G06T 2207/30268; B60R 2011/0003

(57) ABSTRACT

A system for identifying damage caused to a vehicle includes an image capture device connected to a remote server by a transmission module. The image capture device is mobile. A method of identifying the damage caused to the vehicle includes capturing at least one image of the vehicle by an image capture device, transmitting the captured image to a remote server, and processing the captured image. The capturing includes guiding the image capture device toward a predefined zone of the vehicle.

The present invention concerns a method of identifying damage caused to a vehicle, notably a rental fleet vehicle, a company fleet vehicle or a car-club vehicle.

The invention also concerns a system for identifying damage caused to a vehicle.

In the context of vehicle rental, an inspection thereof is often required when picking up or returning the vehicle.

This inspection is systematically carried out by visual inspection of the vehicle by a member of the management staff of the rental company.

This inspection aims to compare the condition of the vehicle with the most recent report on its condition to deduce any new damage caused to the vehicle.

However, carrying out such a procedure is complicated and takes a long time and is very often the cause of numerous human errors, notably because of problems of identifying damage and/or inexact reporting on an identified damage form.

The present invention aims to solve these problems resulting from the deficiencies of the prior art.

In this light, the invention concerns a system for identifying damage caused to a vehicle, comprising an image capture device connected to a remote server by a transmission module, the image capture device being mobile.

In other embodiments:
the image capture device is removably arranged in the passenger compartment of the vehicle, and
the image capture device includes a photosensitive sensor that is sensitive to radiation in a light spectrum included in the infrared band and/or in the visible band.

The invention also concerns a method of identifying damage caused to a vehicle, comprising the following steps:
capturing at least one image of the vehicle by means of an image capture device;
transmitting the captured image to a remote server; and
processing the captured image,
   the capture step comprising a sub-step of guiding the image capture device toward a predefined zone of the vehicle.

In other embodiments:
the processing step comprises a sub-step of comparing the captured image with a reference image corresponding to the same predefined zone;
the guiding sub-step provides for issuing at least one instruction to a user of the image capture device by sound and/or visual means; and
the method comprises after the processing step a step of sending a message to the image capture device and/or another communication device of a user of the image capture device.

The invention also concerns a computer program comprising program code instructions for executing the steps of the above method when said program is executed by a processor unit of an image capture device.

In other embodiments:
the computer program comprises the program code instructions for executing the following steps:
   processing a video stream corresponding to the images captured by the object lens of the image capture device;
   detecting the position of the capture device relative to a predefined zone to be identified;
   generating and issuing instructions as a function of the location of the predefined zone;
   capturing an image corresponding to that predefined zone; and
   connecting to and transmitting the captured image to a remote server;
the issuing of instructions provides for integrating visual instructions and/or a reference image corresponding to the predefined zone in the video stream corresponding to the images captured by the object lens of the image capture device.

Other advantages and features of the invention will become more apparent on reading the following description with reference to the accompanying drawings of a preferred embodiment provided by way of illustrative and nonlimiting example:

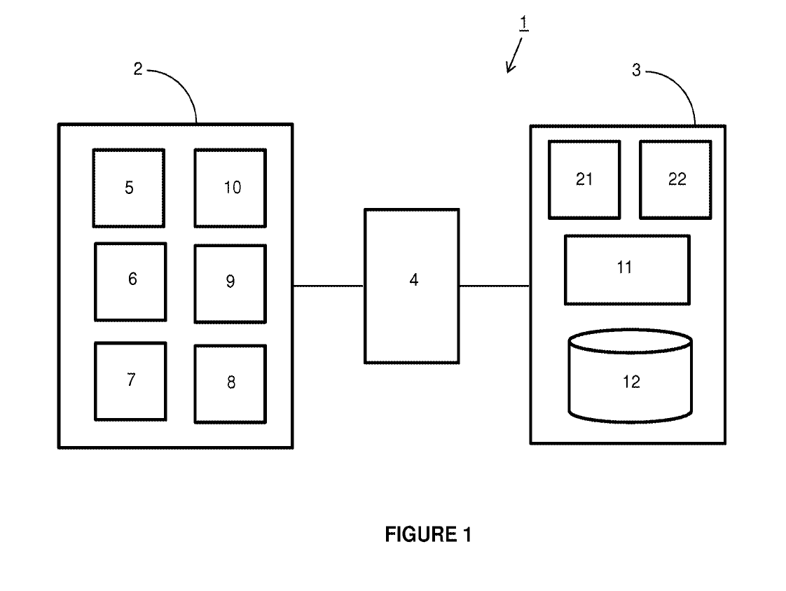

FIG. 1 concerns the system for identifying damage caused to a vehicle in accordance with this embodiment of the invention, and

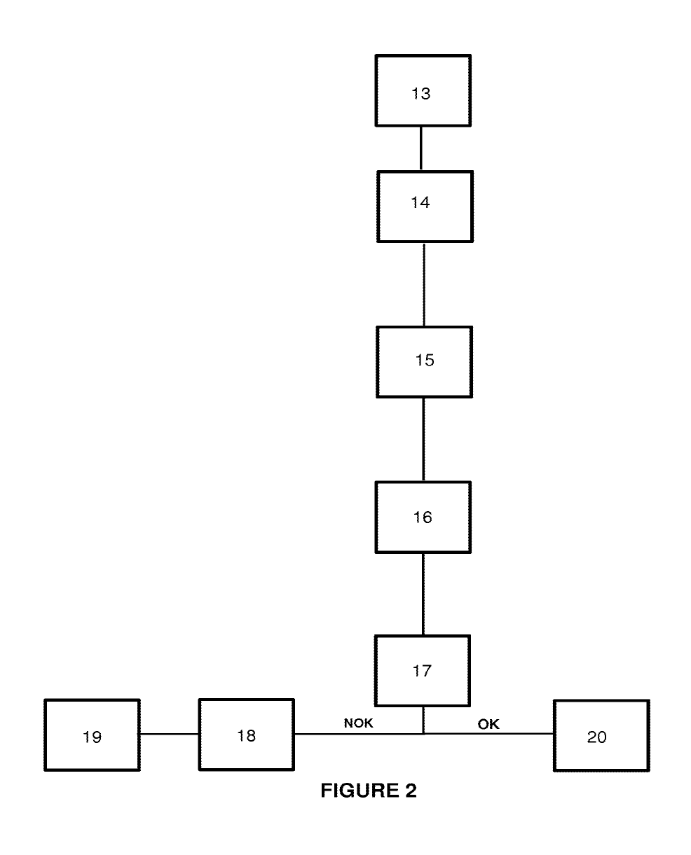

FIG. 2 is a flowchart relating to the method of identifying damage caused to a vehicle in accordance with this embodiment of the invention.

The system 1 for identifying damage caused to a vehicle may be used for a rental fleet vehicle or a car-club vehicle or a company fleet vehicle. These vehicles may consist of any means of locomotion such as an automobile or a bicycle, for example.

For a proper understanding of the invention, there is described here an embodiment used in the context of motor vehicle rental.

In FIG. 1, the system 1 for identifying damage caused to a vehicle includes, non-exhaustively and non-limitingly:
an image capture device 2;
a remote server 3; and
a transmission module 4.

This image capture device 2, making it possible to capture at least one digital image, may comprise:
at least one photosensitive sensor 6;
an object lens 7;
a processor unit 10;
a human-machine interface 9 notably comprising a graphical display interface and an input module;
an audio element 8, e.g. loudspeakers; and a communication component 5.

This image capture device 2 may be removably arranged in the passenger compartment of the vehicle, being connected to a base, for example.

The photosensitive sensor 6 may be a CCD (charge-coupled device) sensor or a CMOS (Complementary Metal Oxide Semiconductor) sensor, for example.

It is adapted to provide signals representing an image that can then be transmitted to the remote server 3 via the transmission module 4 for this image to be archived or processed.

The photosensitive sensor 6 is sensitive to radiation in a light spectrum included in the infrared band and/or in the visible band.

This sensor can therefore be used during the day and also at night, exploiting its ability to detect infrared radiation.

This sensor 6 is associated with a succession of lens type optical elements used as the object lens 7 for forming the image. This object lens 7 can have a short focal length; for example it may be a wide-angle object lens or an object lens 7 making it possible to photograph a 180° field such as a fisheye object lens.

The image capture device 2 also comprises a processor unit 10 including at least one processor cooperating with memory elements, which unit 10 is adapted to execute instructions for implementing a computer program.

The communication component 5 is adapted to connect to and to transmit data from the image capture device 2 to the transmission module 4, which is in the vehicle, for example, using Bluetooth or NFC (Near Field Communication) or Wi-Fi wireless data transmission.

Alternatively, this transmission may be by wire. Indeed, the image capture device 2 may be connected to the transmission module 4 using the USE (Universal Serial Bus) or FireWire™ technology.

To this end, the image capture device 2 is then connected to the transmission module 4 via a base including a connector complementary to that of the image capture device 2, for example, such as a USB connector in the communication component 5.

This image capture device 2 may be a digital still camera, a video camera, an intelligent mobile telephone (smartphone), a personal digital assistant (PDA) or a tablet computer, for example.

The system 1 for identifying damage caused to a vehicle also includes a remote server 3 that can integrate one or more computer central units 11 and comprise one or more databases 12. It may be monitored and managed in the classic way via one or more computer terminals.

The databases 12 notably archive the images captured by the capture device 2 and reference images corresponding to the latest images captured classified according to predefined zones for each vehicle. Archiving the captured images and reference images therefore makes it possible to provide robust tracking of damage caused to each vehicle.

These predefined zones may correspond to interior and exterior surfaces of the vehicle where damage can generally be found.

This remote server 3 includes a communication element enabling exchange of data with the transmission module 4 and hardware and software resources 21 enabling specific processing of the archived and reference images.

This remote server 3 is connected to the image capture device 2 from the transmission module 4.

This transmission module 4 enables long-range wireless communication between this remote server 3 and the image capture device 2 via a terrestrial or satellite wireless telecommunication network (such as the GSM, GPRS, UMTS, WiMAX, etc. networks).

This transmission module 4 may be provided in each rental fleet vehicle.

Alternatively, in this system 1 the communication component 5 of the image capture device 2 may have the same functions as the transmission module 4. This image capture device 2 may then be connected directly to the remote server 3.

In this case, the communication component 5 of the image capture device 2 may have the same characteristics and properties as the transmission module 4.

Such a system 1 is adapted to implement a method of identifying damage caused to a vehicle.

In the context of vehicle rental, when a user returns a vehicle to the rental company, the user of the vehicle then takes possession of the image capture device 2 so as to be able to use it inside and outside the vehicle.

As already indicated, this image capture device 2 may be removably arranged on a base in the passenger compartment of the vehicle.

During an activation step 13, the user starts up the image capture device 2 by actuating a control element on the device, for example.

When starting up, the image capture device 2 executes the computer program from its processor unit 10.

During a step 14 of capturing at least one image, the execution of this computer program generates instructions that are issued to the user of the image capture device 2 audibly, via the sound element 8, and/or visually, via the graphic display interface 9 of the capture device 2, during a sub-step 15 of guiding the image capture device 2.

This guiding sub-step provides for orienting the user toward predefined zones located in different parts of the vehicle that may be inside and/or outside the vehicle.

The processor unit 10 then performs a real time analysis of the images of the video stream captured by the object lens 7 of the capture device 2 in order to determine instantaneously the position of the capture device 2 relative to a predefined zone to be identified and an image of which must be captured.

To this end, the processor unit 10 is adapted to identify the various parts of a vehicle from the images of the video stream by detecting the shapes of each of those parts. These detected shapes are then compared with data relating to the shapes of the part in which the predefined zone to be identified is located or with data for the parts of the vehicle that are near the latter part.

The user therefore receives instructions, notably instructions to move the capture device 2 until the capture device 2 is optimally situated relative to the predefined zone for which an image must be captured.

During this guiding sub-step 15, when these instructions are transmitted via the graphic display interface 9, for example, they may then correspond to:
arrows aiming to have the user orient the image capture device 2 toward a predefined zone of the vehicle, and/or
a selection graphic element, such as a frame, making it possible to target and/or to delimit the predefined zone concerned of the vehicle that must be captured when the capture device is positioned in front of that zone.

If these instructions are transmitted via the graphic display interface 9, they may equally correspond to a combination of real and virtual images, also referred to as augmented reality images, using automatic tracking in real time of the predefined zones concerned in a video stream corresponding to the images captured by the object lens 7 of the image capture device 2.

The object of this augmented reality is to insert one or more virtual objects corresponding to the reference images of these predefined zones into the images from the video stream captured by the image capture device 2.

As previously indicated, these reference images are archived in the databases 12 of the remote server 3 and correspond to the archived images relating to the most recent predefined zones.

In the context of this augmented reality, the image capture device 2 is connected to the remote server 3 so that the reference images are downloaded from the databases 12 to be used by the computer program executed by the processor unit 10.

During the capture step 14, once the image capture device 2 has been positioned in a predefined zone, the latter zone is then captured digitally by this capture device 2.

This image capture may be effected automatically, for example when the processor unit identifies that one of the images from the video stream has substantially the same criteria/characteristics as the expected reference image in the selection graphic element.

In another example relating to augmented reality, when the processor unit determines that the criteria/characteristics of the reference image correspond to those of one of the images from the video stream, relative to which it is superposed.

Alternatively, the processor unit 10 may equally have received beforehand, with the reference image, data corresponding to these specific criteria/characteristics of the reference image on the basis of which it is able to identify the image to be captured in this video stream.

As soon as all the predefined zones of the vehicle have been captured and/or after each of them is captured, the image capture device 2:
establishes a connection with the remote server 3 via the communication component 5 and/or the transmission module 4;
identifies itself to the remote server 3 in accordance with an authentication protocol; and
transmits the captured images relating to the predefined zones of the vehicle to the remote server 3 for archiving or processing thereof by this remote server 3.

The hardware and software resources 21 of the remote server 3 then perform specific processing of the images captured by the image capture device 2 during a processing step 16.

To this end, during a comparison sub-step 17 of the processing step 16, these hardware and software resources 21 compare the captured images with the reference images relating to the same zones of the vehicle.

This comparison sub-step 17 may provide for dividing the captured and reference images for the same zones into different parts and sub-parts in order to carry out a pixel-level comparison.

If the comparison highlights a large number of different pixels, then damage in the zone concerned is identified. This damage may be an impact or a scratch, for example, or even the disappearance of a part of the vehicle.

If no notable difference is identified by the resources 21, the remote server 3 then transmits a message to the user indicating this state of affairs during a step 20 of sending a message.

If not, during a step 18 of transmitting an alert message, a message is then sent to the user advising them of the situation and verification of the presence of this damage in the predefined zones concerned of the vehicle during a visual inspection step 19.

These messages may be sent to the image capture device or to a communication device of the user. These messages may then take the form of a voice message, SMS

(Short Message Service) text message, MMS (Multimedia Messaging Service) message or electronic mail.

As previously indicated, the processor unit 10 is adapted to execute a computer program comprising program code instructions for the execution of the steps of the method.

When this computer program is executed by the processor unit 10, the following steps of the method are carried out:
processing a video stream. corresponding to the images captured by the object lens 7 of the image capture device 2;
detecting the position of the capture device 2 relative to a predefined zone to be identified;
generating and issuing instructions as a function of the location of the predefined zone, the issuing of instructions providing for integration of visual instructions and/or a reference image corresponding to the predefined zone in the video stream captured by the object lens 7 of the capture device 2;
capturing an image corresponding to this predefined zone; and
connecting to and transmitting the captured image to a remote server 3.

The present invention is not limited to the embodiments that have been explicitly described and encompasses diverse variants and generalizations thereof within the scope of the following claims.

1-10. (canceled)

11. A system for identifying damage caused to a vehicle, comprising:
an image capture device connected to a remote server by a transmission module, wherein the image capture device is mobile.

12. The system as claimed in claim 11 wherein the image capture device is removably arranged in a passenger compartment of the vehicle.

13. The system as claimed in claims 12, wherein the image capture device includes a photosensitive sensor that is sensitive to radiation in a light spectrum included in the infrared band and/or in the visible band.

14. The system as claimed in claims 11. wherein the image capture device includes a photosensitive sensor that is sensitive to radiation in a light spectrum included in the infrared band and/or in the visible band.

15. A method of identifying damage caused to a vehicle, comprising capturing at least one image of the vehicle by an image capture device;
transmitting the captured image to a remote server; and
processing the captured image,
wherein the capturing comprises guiding the image capture device toward a predefined zone of the vehicle.

16. The method as claimed in claim 15, wherein the processing comprises comparing the captured image with a reference image corresponding to the same predefined area.

17. The method as claimed in claim 16, wherein the guiding includes issuing at least one instruction to a user of the image capture device by sound and/or visual means.

18. The method as claimed in claim 17, further comprising:
sending, after the processing, a message to the image capture device and/or another communication device of a user of the image capture device.

19. The method as claimed in claim 15, wherein the guiding includes issuing at least one instruction to a user of the image capture device by sound and/or visual means.

20. The method as claimed in claim 15. further comprising:
sending, after the processing, a message to the image capture device and/or another communication device of a user of the image capture device.

21. The method as claimed in claim 16, further comprising:
sending, after the processing, a message to the image capture device and/or another communication device of a user of the image capture device.

22. A non-transitory computer readable medium storing a program that, when said program is executed by a processor unit of an image capture device, causes the computer to execute:
capturing at least one image of the vehicle by the image capture device;
transmitting the captured image to a remote server; and
processing the captured image,
wherein the capturing comprises guiding the image capture device toward a predefined zone of the vehicle.

23. The non-transitory computer readable medium as claimed in claim 22, wherein the program, when said program is executed by the processor unit of the image capture device, causes the computer to execute:
processing a video stream corresponding to images captured by an object lens of the image capture device;
detecting a position of the capture device relative to the predefined zone to be identified;
generating and issuing instructions as a function of a location of the predefined zone;
capturing an image corresponding to the predefined zone; and
connecting to and transmitting the captured image to a remote server.

24. The non-transitory computer readable medium as claimed in claim 23, wherein the issuing of instructions includes integrating visual instructions and/or a reference image corresponding to the predefined zone in the video stream corresponding to the images captured by the object lens of the image capture device.
